(19) United States
(12) Patent Application Publication
(10) Pub. No.: US 2015/0043790 A1
(43) Pub. Date: Feb. 12, 2015

(54) IMAGE PROCESSING APPARATUS AND NON-TRANSITORY COMPUTER READABLE MEDIUM

(71) Applicant: FUJI XEROX CO., LTD, Tokyo (JP)

(72) Inventors: Masafumi ONO, Kanagawa (JP); Manabu HAYASHI, Kanagawa (JP); Naoya NOBUTANI, Kanagawa (JP); Shigeki KATAYAMA, Kanagawa (JP); Yuki NOGUCHI, Kanagawa (JP)

(73) Assignee: FUJI XEROX CO., LTD, Tokyo (JP)

(21) Appl. No.: 14/192,986

(22) Filed: Feb. 28, 2014

(30) Foreign Application Priority Data
Aug. 9, 2013 (JP) 2013-166811

(51) Int. Cl. G06K 9/00

(52) U.S. Cl. CPC G06K 9/00288
USPC 382/118

(57) ABSTRACT

An image processing apparatus includes an image capturing unit, a registration unit, a display, and an authentication unit. The image capturing unit captures a face image of a user. The registration unit registers the captured face image. The display displays, in a case where a face image is to be captured and registered, a guide image for capturing, in addition to a first image which is the face image of the user, at least any one of an upward-oriented image and a downward-oriented image, the upward-oriented image being an image in which a face of the user is oriented upward relative to the first image, the downward-oriented image being an image in which the face is oriented downward relative to the first image. The authentication unit performs face authentication by comparing a face image obtained by the image capturing unit with a registered face image.

### CROSS-REFERENCE TO RELATED APPLICATIONS

This application is based on and claims priority under 35 USC 119 from Japanese Patent Application No. 2013-166811 filed Aug. 9, 2013.

### BACKGROUND

(i) Technical Field

The present invention relates to an image processing apparatus and a non-transitory computer readable medium.

(ii) Related Art

In recent years, face authentication technologies have been developed and become widely available, and have been applied to various fields.

### SUMMARY

According to an aspect of the invention, there is provided an image processing apparatus including an image capturing unit, a registration unit, a display, and an authentication unit. The image capturing unit captures a face image of a user. The registration unit registers the face image captured by the image capturing unit. The display displays, in a case where a face image is to be captured and registered in the registration unit, a guide image for capturing, in addition to a first image which is the face image of the user, at least any one of an upward-oriented image and a downward-oriented image, the upward-oriented image being an image in which a face of the user is oriented upward relative to the first image, the downward-oriented image being an image in which the face of the user is oriented downward relative to the first image. The authentication unit performs face authentication by comparing a face image obtained by the image capturing unit with a registered face image.

### BRIEF DESCRIPTION OF THE DRAWINGS

An exemplary embodiment of the present invention will be described in detail based on the following figures, wherein:

FIG. 1 is a front view of an image processing apparatus;

FIG. 2 is a top view of the image processing apparatus;

FIG. 3 is a block diagram of the configuration of the image processing apparatus;

FIG. 4 is a block diagram of the configuration of a person detecting device of the image processing apparatus;

FIG. 5 is a block diagram of the functional configuration of the image processing apparatus;

FIGS. 6A to 6F are plan views illustrating positional relationships between the image processing apparatus and a person;

FIGS. 7A to 7F are diagrams illustrating face image registration screens; and

FIG. 8 is a diagram illustrating face image registration.

### DETAILED DESCRIPTION

Hereinafter, an exemplary embodiment of the present invention will be described with reference to the drawings.

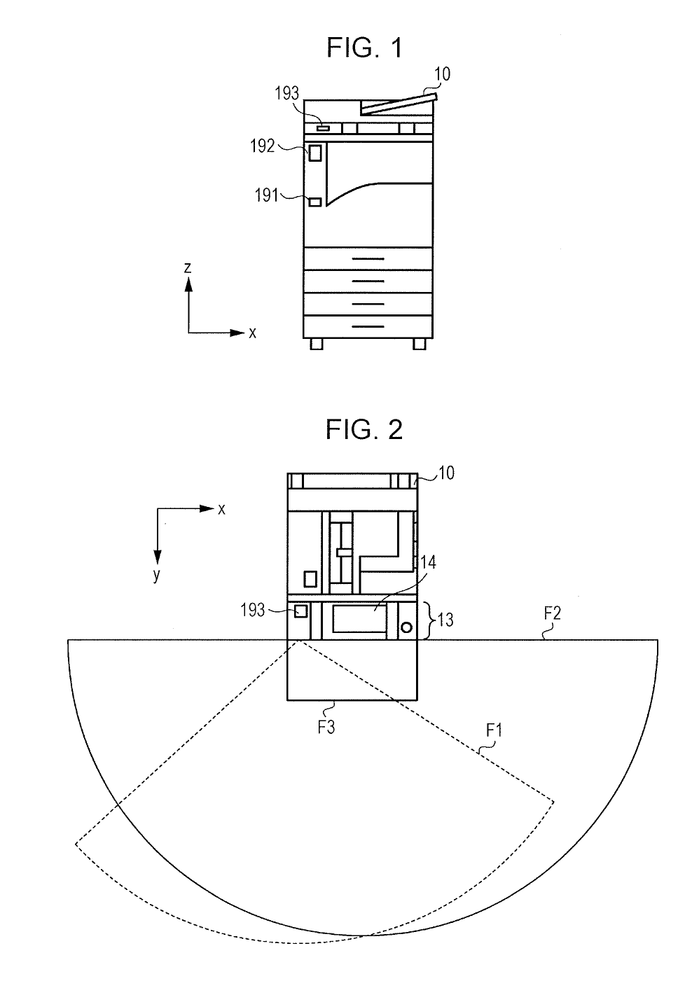

FIG. 1 is a front view of an image processing apparatus 10 according to the exemplary embodiment. FIG. 2 is a top view of the image processing apparatus 10.

The image processing apparatus 10 includes a person detecting sensor 191, a first image capturing unit 192, and a second image capturing unit 193.

The person detecting sensor 191 is constituted by, for example, an infrared sensor, and is provided on a front surface of a housing of the image processing apparatus 10. The person detecting sensor 191 detects a human body existing in a detection region F1 illustrated in FIG. 2, and outputs a detection signal. The detection region F1 is set in front of the image processing apparatus 10, for example, as a fan-shaped region having a radius of 1500 mm and an angle ranging from 90 to 135 degrees with the person detecting sensor 191 being the center.

The first image capturing unit 192 is, for example, a camera including a wide-angle lens, and is provided on the front surface of the housing of the image processing apparatus 10. The first image capturing unit 192 captures an image of a detection region F2 illustrated in FIG. 2. The detection region F2 is set in front of the image processing apparatus 10, for example, as a semicircular region having a radius of 1000 mm with the first image capturing unit 192 being the center.

The second image capturing unit 193 is, for example, a camera, and is provided next to an operation unit 13 and a display 14 on a top surface of the housing of the image processing apparatus 10. The second image capturing unit 193 captures a face image of a user who uses the image processing apparatus 10.

An operation region F3 illustrated in FIG. 2 is a region in which a user stays when he/she operates the image processing apparatus 10, and is set so as to be adjacent to the image processing apparatus 10 in front of the image processing apparatus 10.

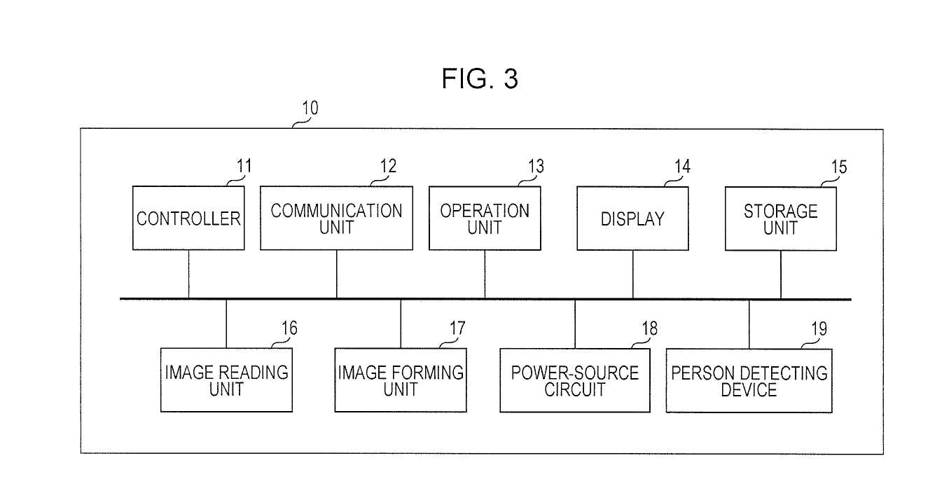

FIG. 3 is a block diagram of the configuration of the image processing apparatus 10. The image processing apparatus 10 includes a controller 11, a communication unit 12, the operation unit 13, the display 14, a storage unit 15, an image reading unit 16, an image forming unit 17, a power-source circuit 18, and a person detecting device 19.

The controller 11 includes, for example, a central processing unit (CPU) and a memory, and controls the individual units of the image processing apparatus 10. The CPU reads out and executes a program stored in the memory or the storage unit 15. The memory includes a read only memory (ROM) and a random access memory (RAM). The ROM stores a program and various pieces of data in advance. The RAM temporarily stores a program and data, and functions as a working area when the CPU executes a program.

The communication unit 12 is a communication interface connected to a communication line. The communication unit 12 communicates with a client apparatus or another image processing apparatus 10 connected to the communication line, via the communication line.

The operation unit 13 is constituted by, for example, a touch panel and keys, and supplies data corresponding to a user operation to the controller 11.

The display 14 is, for example, a liquid crystal display, and displays various pieces of information. The operation unit 13 and the display 14 are provided on the top surface of the housing of the image processing apparatus 10. The operation unit 13 and the display 14 may be integrated together into a touch panel.

The storage unit 15 is a hard disk, a semiconductor memory, or the like, and stores various programs and data used by the controller 11.

The image reading unit 16 is an image scanner, and reads an image of a document and generates image data.

The image forming unit 17 forms an image corresponding to image data on a sheet medium, such as paper. The image forming unit 17 may form an image by using an electrophotographic system, or may form an image by using another method. The image forming unit 17 typically functions as a printer.

The power-source circuit 18 supplies power to the individual units of the image processing apparatus 10.

The person detecting device 19 detects a user of the image processing apparatus 10, and includes the person detecting sensor 191, the first image capturing unit 192, and the second image capturing unit 193.

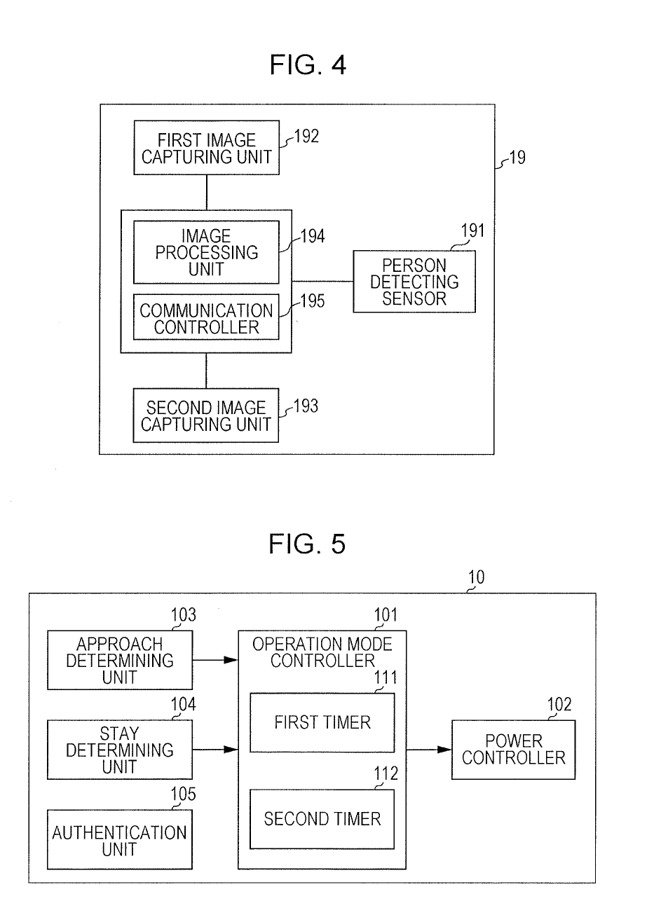

FIG. 4 is a block diagram of the configuration of the person detecting device 19. The person detecting device 19 includes the person detecting sensor 191, the first image capturing unit 192, the second image capturing unit 193, an image processing unit 194, and a communication controller 195.

The image processing unit 194 analyzes an image captured by the first image capturing unit 192 and an image captured by the second image capturing unit 193, and executes various processing operations. The image processing unit 194 may be constituted by a CPU and a memory, or may be constituted by an application specific integrated circuit (ASIC).

The communication controller 195 controls communication performed between the person detecting device 19 and the controller 11. Specifically, when a person is detected from an image captured by the first image capturing unit 192 or the second image capturing unit 193, the communication controller 195 transmits a detection signal to the controller 11.

FIG. 5 is a block diagram of the functional configuration of the image processing apparatus 10. The image processing apparatus 10 includes, as its functions, an operation mode controller 101, a power controller 102, an approach determining unit 103, a stay determining unit 104, and an authentication unit 105.

The operation mode controller 101 is implemented by the controller 11, and controls the operation modes of the individual units of the image processing apparatus 10. The operation mode controller 101 controls the operation modes of a main system of the image processing apparatus 10, the operation modes of the first image capturing unit 192 and the second image capturing unit 193, and the operation modes of the image processing unit 194 and the communication controller 195. The main system corresponds to the configuration of the image processing apparatus 10 except the person detecting device 19, and includes, for example, the image reading unit 16 and the image forming unit 17.

The operation modes of the main system include a standby mode and a sleep mode. In the standby mode, the power that is necessary for operation is supplied to the main system, and an operable state is achieved. After the mode has shifted to the standby mode, the image processing apparatus 10 executes scan processing, copy processing, print processing, or facsimile processing in response to a user operation. In the sleep mode, power supply to at least a part of the main system is stopped, and at least the part of the main system is brought into a non-operation state. In the sleep mode, power supply to a part of the controller 11, and to the display 14, the image reading unit 16, and the image forming unit 17 is stopped.

The operation modes of the first image capturing unit 192 and the second image capturing unit 193 include an ON-state and an OFF-state. In the ON-state, power is supplied to the first image capturing unit 192 and the second image capturing unit 193, and the power of the first image capturing unit 192 and the second image capturing unit 193 is turned on. In the OFF-state, power supply to the first image capturing unit 192 and the second image capturing unit 193 is stopped, and the power of the first image capturing unit 192 and the second image capturing unit 193 is turned off.

The operation modes of the image processing unit 194 and the communication controller 195 include a standby mode and a sleep mode. In the standby mode, the power that is necessary for operation is supplied to the image processing unit 194 and the communication controller 195, and an operable state is achieved. In the sleep mode, power supply to at least a part of the image processing unit 194 and the communication controller 195 is stopped, and the image processing unit 194 and the communication controller 195 are brought into a non-operation state.

The operation mode controller 101 includes a first timer 111 and a second timer 112. The first timer 111 is used to shift the main system to the sleep mode. The second timer 112 is used to bring the first image capturing unit 192 and the second image capturing unit 193 into the OFF-state, and to shift the image processing unit 194 and the communication controller 195 to the sleep mode.

The power controller 102 controls, under control performed by the operation mode controller 101, power supply from the power-source circuit 18 to the individual units of the image processing apparatus 10. The power controller 102 constantly supplies power to the person detecting sensor 191.

The approach determining unit 103 is implemented by the image processing unit 194, and determines, by using an image captured by the first image capturing unit 192, whether or not a person existing in the detection region F2 is approaching the image processing apparatus 10. Specifically, the approach determining unit 103 detects the shape of a person from a captured image and detects the orientation of the person. If the detected human body is oriented toward the image processing apparatus 10, the approach determining unit 103 determines that the person is approaching the image processing apparatus 10. Otherwise, the approach determining unit 103 determines that the person is not approaching the image processing apparatus 10.

The stay determining unit 104 is implemented by the image processing unit 194, and determines, by using an image captured by the first image capturing unit 192, whether or not a person exists in the operation region F3.

The authentication unit 105 is implemented by the image processing unit 194, and authenticates, by using an image captured by the second image capturing unit 193, a user by using the face of the user. Specifically, the authentication unit 105 extracts a face region from an image captured by the second image capturing unit 193, compares features of the extracted face region with features of a pre-registered face image of a user, and thereby determines whether or not the captured image matches the pre-registered face image of the user. If it is determined that the captured image matches the face image of the user, user authentication succeeds. On the other hand, if it is determined that the captured image does not match the face image of the user, user authentication fails. A pre-registered face image of a user will be described below. In this exemplary embodiment, authenticating a user by using a face is referred to as “face authentication”.

The authentication unit 105 may execute, in addition to face authentication processing (first authentication processing), ID and password authentication processing (second authentication processing). Specifically, when a user operates the operation unit 13 or the display 14 to input an ID and a password, the authentication unit 105 compares the ID and the password with pre-registered ID and password of the user, and thereby authenticates the user. Authentication using an ID and a password is executed by the controller 11, not by the image processing unit 194, because a face image is not necessary.

The authentication unit 105 executes face authentication processing by using an image captured by the second image capturing unit 193, and thus it is necessary that the second image capturing unit 193 is in the ON-state. That is, the authentication unit 105 is capable of operating when the second image capturing unit 193 is in the ON-state and when the image processing unit 194 is in the standby mode.

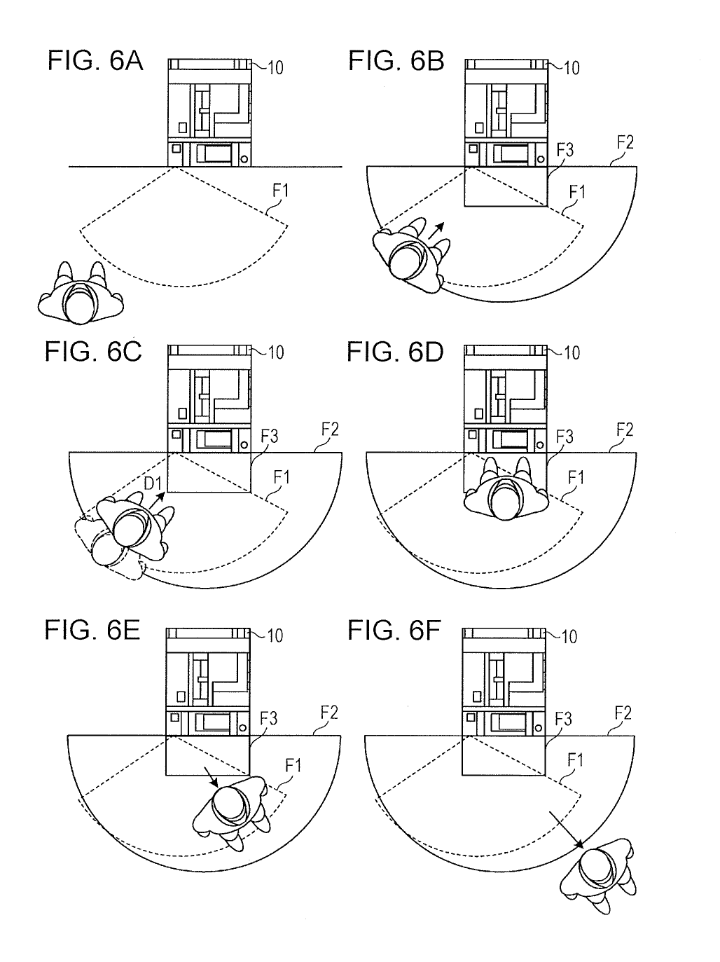

FIGS. 6A to 6F illustrate the positional relationships between the image processing apparatus 10 and a user.

In an initial state, the operation modes of the main system of the image processing apparatus 10, the image processing unit 194, and the communication controller 195 have been shifted to the sleep mode, and the first image capturing unit 192 and the second image capturing unit 193 are in the OFF-state.

When a user does not exist in the detection region F1, as illustrated in FIG. 6A, the person detecting sensor 191 does not detect a user, and a detection signal is OFF.

If the user moves to the detection region F1, as illustrated in FIG. 6B, the person detecting sensor 191 detects the user, and the detection signal is ON. Upon turn-ON of the detection signal of the person detecting sensor 191, the first image capturing unit 192 and the second image capturing unit 193 are activated and shift from the OFF-state to the ON-state, and the image processing unit 194 and the communication controller 195 shift from the sleep mode to the standby mode.

The first image capturing unit 192 captures an image of the detection region F2 at a certain time interval while it is activated. If an image is captured by the first image capturing unit 192, approach determination processing and stay determination processing are executed.

If the user moves in a direction D1 to approach the image processing apparatus 10, as illustrated in FIG. 6C, it is determined in approach determination processing that the user is approaching the image processing apparatus 10, and the main system shifts from the sleep mode to the standby mode.

If the user moves into the operation region F3, as illustrated in FIG. 6D, it is determined in stay determination processing that the user exists in the operation region F3, and the main system is maintained in the standby mode. In the state illustrated in FIG. 6D, user authentication is executed. During face authentication, a face image of the user is captured by the second image capturing unit 193.

After the user has finished using the image processing apparatus 10, performed certain logout processing on the image processing apparatus 10, and moved to the outside of the operation region F3 with his/her back to the image processing apparatus 10, as illustrated in FIG. 6E, it is determined in stay determination processing that the user does not exist in the operation region F3. In this case, the first timer 111 is activated, and measurement of a set time T1 is started.

Finally, if the user moves to the outside of the detection region F1, as illustrated in FIG. 6F, the person detecting sensor 191 does not detect the user any more, and thus the detection signal becomes OFF. After the detection signal has become OFF, the second timer 112 is activated, and measurement of a set time T2 is started. After the time measured by the second timer 112 exceeds the set time T2, it is determined whether or not the operation mode of the main system is the sleep mode. In a case where the main system is in the standby mode, the standby mode is maintained even after the set time T2 has elapsed. After the time measured by the first timer 111 exceeds the set time T1, the main system shifts from the standby mode to the sleep mode. Also, the first image capturing unit 192 and the second image capturing unit 193 shift from the ON-state to the OFF-state, and the image processing unit 194 and the communication controller 195 shift to the sleep mode.

Focusing on the second image capturing unit 193, the image processing unit 194, and the communication controller 195, the second image capturing unit 193 comes into the ON-state at the timing when the user moves into the detection region F1, as illustrated in FIG. 6B, and the image processing unit 194 and the communication controller 195 shift to the standby mode. At the timing when the user approaches the image processing apparatus 10, as illustrated in FIG. 6C, the main system shifts from the sleep mode to the standby mode, and the operation unit 13 and the display 14 are supplied with power and are turned ON. At this time, face authentication of the user may be performed. After the user has finished operation, and after the set time T1 has elapsed since the user moved to the outside of the detection region F1 with his/her back to the image processing apparatus 10, as illustrated in FIG. 6F, the main system shifts to the sleep mode, the second image capturing unit 193 comes into the OFF-state, and the image processing unit 194 and the communication controller 195 shift to the sleep mode. In this state, face authentication is not performed.

As described above, in the state illustrated in FIG. 6D, that is, in a case where the user exists in the operation region F3, the second image capturing unit 193 captures a face image of the user and supplies the face image to the image processing unit 194. The image processing unit 194 extracts information from the face image captured by the second image capturing unit 193, compares the extracted information with the face image of a valid user that is pre-registered and stored in a memory, and authenticates the user if both of them match each other.

The face image that is pre-registered and stored in the memory is an image that has been captured by the second image capturing unit 193 and has been stored in the memory before the user actually uses the image processing apparatus 10. However, even the same user may have a difference in its height, for example, the height at the time of registration may be different from the height at the time of face authentication. For example, the user may wear low-heeled shoes at the time of registration and may wear high-heeled shoes at the time of face authentication, and vice versa. In a case where the user is higher at the time of registration than at the time of face authentication, the face position of the user in an image captured by the second image capturing unit 193 at the time of face authentication is lower than the second image capturing unit 193 compared to the time of registration, and a downward-oriented face image captured in a downward direction is obtained. In a case where the user is lower at the time of registration than at the time of face authentication, the face position of the user in an image captured by the second image capturing unit 193 at the time of face authentication is higher than the second image capturing unit 193 compared to the time of registration, and an upward-oriented face image captured in an upward direction is obtained. In the case of extracting features through comparison between such an upward-oriented face image or downward-oriented face image and the face image of a valid user registered and stored in the memory, because the two face images compared with each other have different face angles, it may be difficult to compare the features compared to the case of comparing images of the same face angle.

In the image processing apparatus 10 according to this exemplary embodiment, at least any one of an upward-oriented image and a downward-oriented image, as well as a front face image of a user, is captured by the second image capturing unit 193 and the captured image is registered in the memory, at the time of registration of a face image before face authentication.

That is, any one of the following (1) to (3) is registered in this exemplary embodiment.

(1) front face image+upward-oriented face image

(2) front face image+downward-oriented face image

(3) front face image+upward-oriented face image+downward-oriented face image

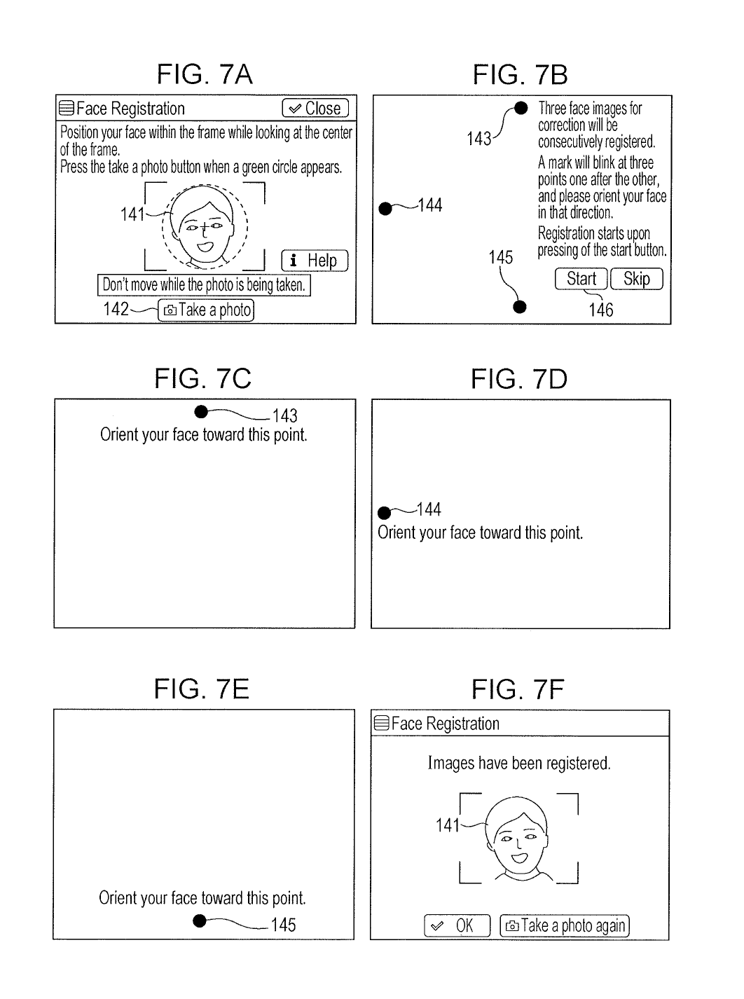

FIGS. 7A to 7F illustrate transition of a display screen of the display 14 at the time of face registration that is performed before face authentication. Face registration may be performed by a user who wants to perform face authentication by operating the operation unit 13 at certain timing. The image processing apparatus 10 may determine whether or not a pre-registered face image exists, and, at the time when it is determined that the pre-registered face image does not exist, a message prompting the user to perform face registration may be displayed on the display 14, so as to perform face registration processing.

FIG. 7A illustrates an initial screen for face registration processing. On this screen, a face image 141 of a user captured by the second image capturing unit 193 is displayed, and also a take a photo button 142 is displayed. Further, an additional message such as “Don't move while the photo is being taken.” is displayed. When the user operates the take a photo button 142 after positioning his/her face within a frame, the second image capturing unit 193 captures a face image in response to the operation of the take a photo button 142 (that is, an image signal obtained by the image sensor of the second image capturing unit 193 at this time is read out and obtained), and transmits the face image to the image processing unit 194. The image processing unit 194 registers the face image obtained at this time, which serves as a “front image”, in the memory.

The “front image” is an example of a first image according to an exemplary embodiment of the present invention, and is an image captured when the user's face is oriented toward the display 14. After the image has been captured on the screen illustrated in FIG. 7A, the screen changes to the screen illustrated in FIG. 7B.

FIG. 7B illustrates a guide screen for capturing an upward-oriented image, a downward-oriented image, and an image of a user oriented toward the second image capturing unit 193, which serve as correction images. A guide mark 143, which is an example of a guide sign used to capture an upward-oriented image, a guide mark 145, which is an example of a guide sign used to capture a downward-oriented image, and a guide mark 144 used to capture an image of a user oriented toward the second image capturing unit 193 are simultaneously displayed, and also a start button 146 is displayed. Further, a message such as “Three face images for correction will be consecutively registered. A black-circle mark will blink at three points one after the other, and please orient your face in that direction. Registration starts upon pressing of the start button.” is displayed.

The guide mark 143 is displayed in an upper portion of the screen of the display 14, the guide mark 145 is displayed in a lower portion of the screen of the display 14, and the guide mark 144 is displayed in a left portion of the screen of the display 14, in consideration of the relative positional relationship between the display 14 and the second image capturing unit 193. That is, as illustrated in the top view in FIG. 2, the second image capturing unit 193 is located on the left side of the display 14, that is, the second image capturing unit 193 and the display 14 are located at different positions. Thus, a face image captured by the second image capturing unit 193 in a case where the face is oriented toward the display 14 is different from a face image captured by the second image capturing unit 193 in a case where the face is oriented toward the second image capturing unit 193. Thus, the guide mark 144 is displayed in a left portion of the screen of the display 14 so that the user orients his/her face toward the second image capturing unit 193, and an image is captured. The face in the image captured in this manner is more front-oriented than the face in an image captured in a state where the face is oriented toward the display screen.

The display position of the guide mark 144 is determined in accordance with the relative positional relationship between the second image capturing unit 193 and the display 14. Thus, the display position of the guide mark 144 normally changes if the set position of the second image capturing unit 193 changes. For example, if the second image capturing unit 193 is provided on the right side of the display 14, the guide mark 144 is displayed on a right portion of the screen of the display 14. When the user operates the start button 145 on the screen illustrated in FIG. 7B, the screen changes to the guide screen illustrated in FIG. 7C.

In FIG. 7C, only the guide mark 143 blinks, which prompts the user to orient his/her face toward the guide mark 143. When the user orients his/her face toward the guide mark 143 in response to the blink of the guide mark 143, the second image capturing unit 193 captures a face image at certain timing and transmits the face image to the image processing unit 194. The image processing unit 194 registers the face image, which serves as an “upward-oriented image”, in the memory.

In FIG. 7C, the take a photo button 142 illustrated in FIG. 7A is not displayed. That is, in FIG. 7C, a face image of a user is automatically captured when the image processing apparatus 10 determines that the orientation of the user face satisfies a certain condition. For example, an image is automatically captured after three seconds from the shift to the screen illustrated in FIG. 7C. In FIG. 7C, the face image 141 is not displayed. After the upward-oriented image of the user has been captured, the screen changes to the guide screen illustrated in FIG. 7D.

In FIG. 7D, only the guide mark 144 blinks, which prompts the user to orient his/her face toward the guide mark 144. When the user orients his/her face toward the guide mark 144 in response to the blink of the guide mark 144, the second image capturing unit 193 captures a face image at certain timing and transmits the face image to the image processing unit 194. The image processing unit 194 registers the face image, which serves as an “image oriented toward the second image capturing unit 193”, in the memory.

In FIG. 7D, the take a photo button 142 illustrated in FIG. 7A is not displayed. That is, in FIG. 7D, a face image of a user is automatically captured when the image processing apparatus 10 determines that the orientation of the user face satisfies a certain condition. Also, the face image 141 is not displayed. After the image oriented toward the second image capturing unit 193 of the user has been captured, the screen changes to the guide screen illustrated in FIG. 7E.

In FIG. 7E, only the guide mark 145 blinks, which prompts the user to orient his/her face toward the guide mark 145. When the user orients his/her face toward the guide mark 145 in response to the blink of the guide mark 145, the second image capturing unit 193 captures a face image at certain timing and transmits the face image to the image processing unit 194. The image processing unit 194 registers the face image, which serves as a “downward-oriented image”, in the memory.

In FIG. 7E, the take a photo button 142 illustrated in FIG. 7A is not displayed. In FIG. 7E, a face image of a user is automatically captured when the image processing apparatus 10 determines that the orientation of the user face satisfies a certain condition. Also, the face image 141 is not displayed. After the downward-oriented image of the user has been captured, the screen changes to the screen illustrated in FIG. 7F.

In FIG. 7F, the face image 141 captured by the second image capturing unit 193 is displayed again, and a message indicating that face registration has been completed is displayed. In this way, “front image”, “upward-oriented image”, “downward-oriented image”, and “image oriented toward the second image capturing unit 193” of the user are registered.

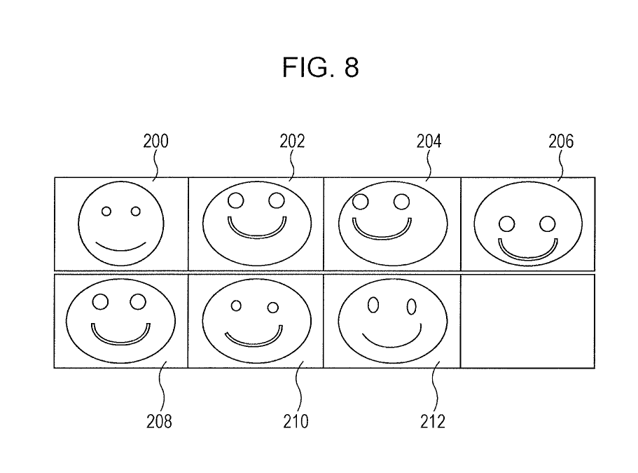

FIG. 8 schematically illustrates face images registered in the memory of the image processing unit 194. A front image 200, an upward-oriented image 202, an image 204 oriented toward the second image capturing unit 193, and a downward-oriented image 206 are registered in the memory. The image processing unit 194, that is, the authentication unit 105 illustrated in FIG. 5, compares a face image of a user with these registered images 200 to 206, and calculates the similarity or correlation therebetween. A method for calculating the similarity or correlation in face authentication is available in the related art. If the similarity or correlation exceeds a certain threshold, it is determined that both the images match each other, and the user is authenticated as a valid user.

Face images 208 to 212 are updated face images. That is, in a case where face authentication succeeds, a face image of the user at that time is newly registered in the memory for update. Accordingly, the accuracy of face authentication may be maintained or increased even if the face image of the user changes over time. In FIG. 8, the face images 200 to 206 serve as fixed information, and the face images 208 to 212 serve as information that is sequentially updated. In a case where the user is oriented toward the display 14 at the time of face authentication, the front image of the user is updated. In a case where the user is relatively upward-oriented at the time of face authentication, the upward-oriented image is updated.

An exemplary embodiment of the present invention has been described above. The exemplary embodiment of the present invention is not limited thereto, and various modifications may be implemented.

For example, according to the above-described exemplary embodiment, shoes are regarded as a cause of change in the height of the user, but the exemplary embodiment of the present invention is not limited thereto.

Also, in the above-described exemplary embodiment, at least any one of an upward-oriented image and a downward-oriented image of a user is captured by the second image capturing unit 193 and is registered in the memory of the image processing unit 194. Alternatively, the controller 11 may create at least any one of an upward-oriented image and a downward-oriented image from a front image registered in the memory by using computer graphics (CG), and may register the created image. A technique of creating an image captured from a different viewpoint by using an image captured from a certain viewpoint is available in the related art. In this case, an upward-oriented image and a downward-oriented image are automatically created and are registered in the memory in the image processing apparatus 10. Thus, the guide screens and guide marks illustrated in FIGS. 7B to 7E are not necessary. In this exemplary embodiment, as described above with reference to FIGS. 7A to 7F, an upward-oriented image, a downward-oriented image, and an image oriented toward the second image capturing unit 193 are automatically captured at certain timings, and thus there is a possibility that desired images are not captured and image capturing fails. In such a case, images created using CG may be registered.

Further, in this exemplary embodiment, the screen automatically changes to the guide screen illustrated in FIG. 7D after automatic image capturing is performed at certain timing in the guide screen illustrated in FIG. 7C, the screen automatically changes to the guide screen illustrated in FIG. 7E after automatic image capturing is performed at certain timing in the guide screen illustrated in FIG. 7D, and the screen automatically changes to the screen illustrated in FIG. 7F after automatic image capturing is performed at certain timing in the guide screen illustrated in FIG. 7E. Alternatively, a message such as “An image has been captured and registered.” may be displayed after automatic image capturing is performed at certain timing, and then the screen may be automatically changed to the next guide screen. That is, in this exemplary embodiment, an upward-oriented image, a downward-oriented image, and an image oriented toward the second image capturing unit 193 are automatically captured regardless of a user's image capturing operation. However, according to an exemplary embodiment of the present invention, processing for notifying a user of the processing performed in the image processing apparatus 10 involved in automatic image capturing is not excluded.

Further, in this exemplary embodiment, as illustrated in FIGS. 7C to 7E, the face image 141 captured by the second image capturing unit 193 is not displayed when a guide screen is displayed on the display 14. This is because, if the face image 141 is displayed, the line of sight of the user is directed toward the face image 141, not toward the guide mark. For this reason, it is desirable that the face image 141 and other marks or massages be not displayed on a guide screen. For example, it is desirable that a message in small characters be displayed near the guide mark 143, in addition to the guide mark 143, as illustrated in FIG. 7C. Regarding the guide marks 143 to 145, black circles are used in this exemplary embodiment, but of course the guide marks are not limited thereto, and any other marks including crosses or arrows may be used. In addition to or instead of a guide mark, a numeral representing countdown may be displayed. In this case, automatic image capturing may be performed and the screen may be automatically changed to the next guide screen when the numeral representing countdown becomes zero.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image capturing unit that captures a face image of a user;
a registration unit that registers the face image captured by the image capturing unit;
a display that displays, in a case where a face image is to be captured and registered in the registration unit, a guide image for capturing, in addition to a first image which is the face image of the user, at least any one of an upward-oriented image and a downward-oriented image, the upward-oriented image being an image in which a face of the user is oriented upward relative to the first image, the downward-oriented image being an image in which the face of the user is oriented downward relative to the first image; and
an authentication unit that performs face authentication by comparing a face image obtained by the image capturing unit with a registered face image.

2. An image processing apparatus comprising:
an image capturing unit that captures a face image of a user;
a registration unit that registers the face image captured by the image capturing unit; and
an authentication unit that performs face authentication by comparing a face image obtained by the image capturing unit with a face image registered in the registration unit,
wherein the registration unit registers, in addition to a first image which is the face image of the user, at least any one of an upward-oriented image and a downward-oriented image, the upward-oriented image being an image in which a face of the user is oriented upward relative to the first image, the downward-oriented image being an image in which the face of the user is oriented downward relative to the first image.

3. The image processing apparatus according to claim 1, wherein the display displays, in a case where at least any one of the upward-oriented image and the downward-oriented image of the user is to be captured, at least any one of a guide sign for the upward-oriented image and a guide sign for the downward-oriented image, so as to guide an orientation of the face of the user.

4. The image processing apparatus according to claim 1, wherein, in a case where at least any one of the upward-oriented image and the downward-oriented image is to be captured, the at least any one of the upward-oriented image and the downward-oriented image is automatically captured by the image capturing unit regardless of a capturing instruction from the user after the guide image has been displayed.

5. The image processing apparatus according to claim 3, wherein, in a case where at least any one of the upward-oriented image and the downward-oriented image is to be captured, the at least any one of the upward-oriented image and the downward-oriented image is automatically captured by the image capturing unit regardless of a capturing instruction from the user after the guide image has been displayed.

6. The image processing apparatus according to claim 4, wherein, in a case where the first image is to be captured, the first image is captured in response to a capturing instruction from the user.

7. The image processing apparatus according to claim 5, wherein, in a case where the first image is to be captured, the first image is captured in response to a capturing instruction from the user.

8. The image processing apparatus according to claim 1, wherein, in a case where the first image is to be captured, the display displays a face image of the user at a time of capturing, and, in a case where at least any one of the upward-oriented image and the downward-oriented image is to be captured, the display does not display a face image of the user at a time of capturing.

9. The image processing apparatus according to claim 3, wherein, in a case where the first image is to be captured, the display displays a face image of the user at a time of capturing, and, in a case where at least any one of the upward-oriented image and the downward-oriented image is to be captured, the display does not display a face image of the user at a time of capturing.

10. The image processing apparatus according to claim 4, wherein, in a case where the first image is to be captured, the display displays a face image of the user at a time of capturing, and, in a case where at least any one of the upward-oriented image and the downward-oriented image is to be captured, the display does not display a face image of the user at a time of capturing.

11. The image processing apparatus according to claim 5, wherein, in a case where the first image is to be captured, the display displays a face image of the user at a time of capturing, and, in a case where at least any one of the upward-oriented image and the downward-oriented image is to be captured, the display does not display a face image of the user at a time of capturing.

12. The image processing apparatus according to claim 6, wherein, in a case where the first image is to be captured, the display displays a face image of the user at a time of capturing, and, in a case where at least any one of the upward-oriented image and the downward-oriented image is to be captured, the display does not display a face image of the user at a time of capturing.

13. The image processing apparatus according to claim 7, wherein, in a case where the first image is to be captured, the display displays a face image of the user at a time of capturing, and, in a case where at least any one of the upward-oriented image and the downward-oriented image is to be captured, the display does not display a face image of the user at a time of capturing.

14. The image processing apparatus according to claim 1, wherein
the image capturing unit and the display are located so as to be separated from each other, and
the display further displays, in a case where a face image serving as a target to be compared for face authentication is to be captured and registered, a guide image for capturing an image in which the face of the user is oriented toward the image capturing unit rather than the display.

15. A non-transitory computer readable medium storing a program causing a computer to execute a process, the process comprising:
displaying, in a case where a face image serving as a target to be compared for face authentication is to be captured by an image capturing unit and registered, a guide image on a display, the guide image being used for capturing, in addition to a first image, at least any one of an upward-oriented image and a downward-oriented image, the upward-oriented image being an image in which a face of a user is oriented upward relative to the first image, the downward-oriented image being an image in which the face of the user is oriented downward relative to the first image;
registering, in a memory, the first image and at least any one of the upward-oriented image and the downward-oriented image; and
performing face authentication by comparing a face image obtained by the image capturing unit with an image registered in the memory.
